(19) United States
(12) Patent Application Publication
(10) Pub. No.: US 2026/0162031 A1
(43) Pub. Date: Jun. 11, 2026

(54) WORKLOAD ESTIMATION SYSTEM, WORKLOAD MANAGEMENT SYSTEM, WORKLOAD ESTIMATION METHOD, AND PROGRAM

(71) Applicant: Panasonic Intellectual Property Management Co., Ltd., Osaka (JP)

(72) Inventors: Kenichi IRIE, Osaka (JP); Kengo ABE, Nara (JP); Tomonori YAMADA, Osaka (JP); Tatsuki NISHIDA, Osaka (JP); Takuma SHIRAI, Osaka (JP)

(73) Assignee: Panasonic Intellectual Property Management Co., Ltd., Osaka (JP)

(21) Appl. No.: 18/709,658

(22) PCT Filed: Nov. 10, 2022
(86) PCT No.: PCT/JP2022/041974

§ 371 Date: May 13, 2024

(30) Foreign Application Priority Data
Nov. 30, 2021 (JP) 2021-194842

(51) Int. Cl. G06Q 10/0631; G06Q 10/0639

(52) U.S. Cl. CPC G06Q 10/063114; G06Q 10/0639

(57) ABSTRACT

A workload estimation system includes a workload estimation unit and a data output unit. The workload estimation unit estimates a workload status based on at least one of business assignment data about a history of business assignments that have been performed by a person or human resources data about human resources of the person. The data output unit outputs estimation data including an estimation result about the workload status.

### TECHNICAL FIELD

The present disclosure relates to a workload estimation system, a workload management system, a workload estimation method, and a program.

### BACKGROUND ART

Patent Literature 1 discloses an engagement estimation device which enables estimating an engagement without sending out a questionnaire.

The engagement estimation device is connected to a database via a communications network to acquire various pieces of information from the database. The database stores group information on a group-by-group basis. The group information includes attribute information on a group basis, network information, and engagement information.

The engagement estimation device estimates the engagement of a target group in the following manner.

Specifically, the engagement estimation device selects, in accordance with the group information acquired from the database with respect to the respective groups, a group that presents network information with a feature quantity similar to the feature quantity of the network information about the target group. The engagement estimation device extracts, as first engagement information, the engagement information about the group thus selected.

Also, the engagement estimation device selects, in accordance with the group information acquired from the database with respect to the respective groups, a group that presents attribute information similar to the attribute information about the target group. The engagement estimation device extracts, as second engagement information, the engagement information about the group thus selected.

Then, an engagement calculation unit calculates an average of engagement values based on the first engagement information and the second engagement information and estimates the average value as the engagement value of the target group.

This technique of Patent Literature 1 enables estimating the engagement of the target group without requiring conducting a questionnaire (survey) but does not enable estimating the workload status on a person-by-person basis.

### CITATION LIST

### Patent Literature

Patent Literature 1: JP 2020-135543 A

### SUMMARY OF INVENTION

An object of the present disclosure is to provide a workload estimation system, a workload management system, a workload estimation method, and a program, all of which enable estimating the workload status on a person-by-person basis without requiring conducting a survey.

A workload estimation system according to an aspect of the present disclosure estimates a workload status indicating a degree of load placed by work on a person. The workload estimation system includes a workload estimation unit and a data output unit. The workload estimation unit estimates the workload status based on at least one of business assignment data about a history of business assignments that have been performed by the person or human resources data about human resources of the person. The data output unit outputs estimation data including an estimation result about the workload status.

A workload management system according to another aspect of the present disclosure includes: the workload estimation system described above; and a display device that displays the estimation data.

A workload estimation method according to still another aspect of the present disclosure is designed to be performed by a workload estimation system for estimating a workload status indicating a degree of load placed by work on a person. The workload estimation method includes a workload estimating step and a data outputting step. The workload estimating step includes estimating the workload status based on at least one of business assignment data about a history of business assignments that have been performed by the person or human resources data about human resources of the person. The data outputting step includes outputting estimation data including an estimation result about the workload status.

A program according to yet another aspect of the present disclosure is designed to cause a computer system to perform the workload estimation method described above.

### BRIEF DESCRIPTION OF DRAWINGS

FIG. 1 is a block diagram showing a configuration for a workload management system including a workload estimation system according to an exemplary embodiment;

FIG. 2 shows a general structure of a company to which employees as targets of estimation for the workload estimation system belong;

FIG. 3 is a perspective view illustrating an employee as a target of estimation for the workload estimation system;

FIG. 4 is a graph showing the time series data of an index for use in the workload estimation system;

FIG. 5 is a graph showing the time series data about a total usage time of a terminal device in the workload estimation system;

FIG. 6 illustrates how the workload estimation system performs estimation processing;

FIG. 7 illustrates how to perform estimation processing according to a first variation of the exemplary embodiment;

FIG. 8 illustrates how to perform estimation processing according to a second variation of the exemplary embodiment;

FIG. 9 illustrates how to perform estimation processing according to a third variation of the exemplary embodiment;

FIG. 10 is a block diagram showing a configuration for a workload management system including a workload estimation system according to a fourth variation of the exemplary embodiment;

FIG. 11 is a graph showing the time series data of an index for use in a fifth variation of the exemplary embodiment; and

FIG. 12 is a flowchart showing the procedure of a workload estimation method according to a ninth variation of the exemplary embodiment.

### DESCRIPTION OF EMBODIMENTS

An exemplary embodiment to be described below generally relates to a workload estimation system, a workload management system, a workload estimation method, and a program. More particularly, the exemplary embodiment to be described below relates to a workload estimation system, a workload management system, a workload estimation method, and a program, all of which may be used to estimate a workload status of a person. Note that the exemplary embodiment to be described below is only an exemplary one of various embodiments of the present disclosure and should not be construed as limiting. Rather, the exemplary embodiment may be readily modified in various manners depending on a design choice or any other factor without departing from the scope of the present disclosure.

### (1) Overview of Workload Management System

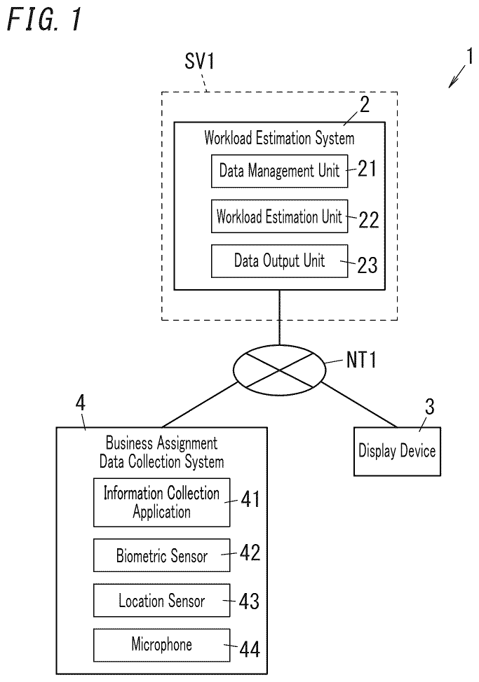

A workload management system 1 shown in FIG. 1 includes a workload estimation system 2 and a display device 3.

The workload estimation system 2 estimates a workload status indicating a degree of load placed by work on a person. The workload estimation system 2 includes a workload estimation unit 22 and a data output unit 23. The workload estimation unit 22 estimates the workload status based on at least one of business assignment data about a history of business assignments that have been performed by the person or human resources data about human resources of the person. The data output unit 23 outputs estimation data including an estimation result about the workload status.

The display device 3 displays the estimation data.

The workload management system 1 and workload estimation system 2 having such a configuration may estimate the workload status on a person-by-person basis without requiring conducting a survey.

### (2) Details of Workload Management System

FIG. 1 illustrates an exemplary specific configuration for the workload management system 1. The workload management system 1 includes the workload estimation system 2 and the display device 3. The workload management system 1 preferably further includes a business assignment data collection system 4. The workload estimation system 2, the display device 3, and the business assignment data collection system 4 are connected to a network NT1 such as the Internet and configured to communicate with each other via the network NT1.

The workload management system 1 manages the workload status of a person belonging to an organization. The organization may be, for example, a company, a corporation, an enterprise, or an association. A number of persons belong to the organization. Each person belonging to the organization performs work that the organization requires or asks him or her to do.

In recent years, an organization where a plurality of persons work has been increasingly required to improve an engagement. As persons belonging to an organization feel an increasing sense of ease at workplace, job satisfaction, and sympathy with respect to the organization, the engagement improves more and more significantly. Thus, to improve the engagement at an organization, the workload management system 1 manages the workload statuses of persons belonging to the organization. In the following description, the organization is supposed to be a company and the persons belonging to the organization are supposed to be employees.

### (2.1) Business Assignment Data Collection System

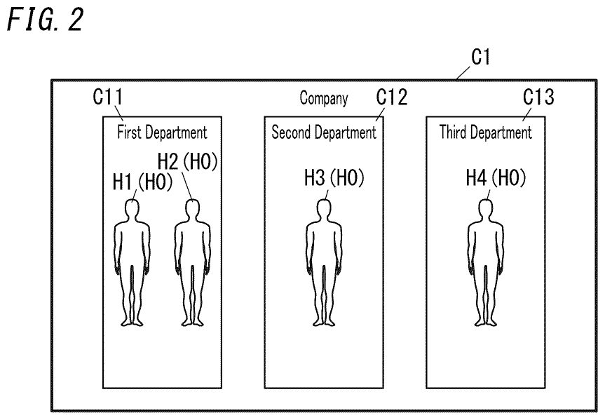

The business assignment data collection system 4 collects the respective business assignment data of a plurality of employees H0 belonging to a company C1 shown in FIG. 2. When the plurality of employees H0 need to be distinguished from each other, the employees H0 will be hereinafter referred to as “employees H1, H2, H3, H4, and so on.” A plurality of departments that form the company C1 includes a first department C11, a second department C12, and a third department C13. The employees H1, H2 belong to the first department C11. The employee H3 belongs to the second department C12. The employee H4 belongs to the third department C13.

The business assignment data preferably includes at least one of terminal operating information, biometric information, location information, or speech information. In this embodiment, the business assignment data includes terminal operating information, biometric information, location information, and speech information.

The business assignment data collection system 4 includes an information collection application 41, a biometric sensor 42, a location sensor 43, and a microphone 44.

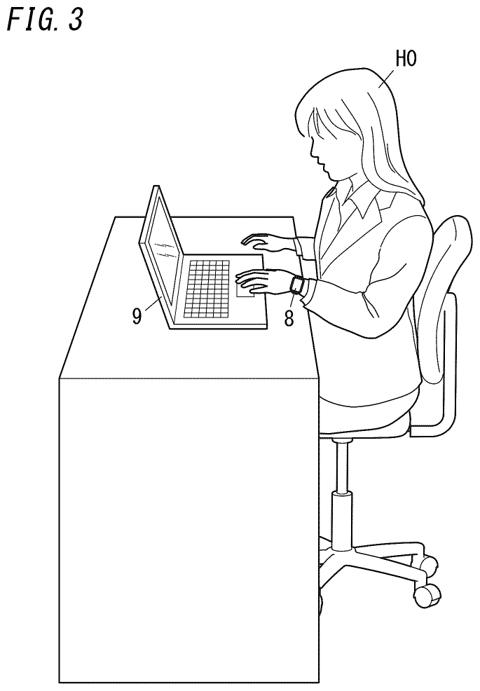

The terminal operating information is a piece of information about the operation performed by the employee H0 on a terminal device. In the company C1, the employee H0 performs various types of jobs such as preparing documents, inputting data, viewing data, teleconferencing, and sending and receiving messages by operating a terminal device 9 (refer to FIG. 3) such as a personal computer, a tablet computer, or a smartphone. First identification information has been assigned in advance on a terminal device basis to each terminal device 9. The information collection application 41 has been installed in the terminal device 9. The information collection application 41 collects terminal operating information about the operations performed on the terminal device 9 and transmits the terminal operating information thus collected, along with the first identification information, to the workload estimation system 2 intermittently (at regular intervals).

The terminal operating information is information about at least one of: operating a keyboard included in the terminal device 9; operating a mouse included in the terminal device 9; input of speech into a microphone included in the terminal device 9; an operation of a camera included in the terminal device 9; activation of an application to be executed by the terminal device 9; an operation of the application; the type of the application being executed on an active window; the type of the application activated; the number of the applications activated; and the number of windows opened by execution of the application. In this embodiment, the terminal operating information includes information about the operation performed on the keyboard; the operation performed on the mouse; the input of speech into the microphone; the operation of the camera; the activation of the application; the operation of the application; the type of the application being executed on the active window; the type of the application activated; the number of the applications activated; and the number of windows opened by execution of the application.

The biometric information is information about at least one of: a heart rate of the employee H0; the body temperature of the employee H0; or acceleration of a body region of the employee H0 involved with his or her movement. In this embodiment, the biometric information includes information about the employee's H0 heart rate, the employee's H0 body temperature, and the acceleration of the employee's H0 body region involved with his or her movement. Examples of the acceleration of the employee's H0 body region involved with his or her movement include the acceleration of his or her legs while he or she is walking and while he or she is running, the acceleration of the arm or wrist that he or she is swinging or rolling, and acceleration of the body involved with his or her movement. The biometric information preferably further includes a breathing rate (which may be either a respiratory cycle or a respiratory rate per unit time), a body fat percentage, a basal metabolic rate, the amount of activity, and the oxygen level in the blood.

The location information is a piece of information indicating the location of the employee H0. The speech information is a piece of information about the speech uttered by the employee H0.

The biometric sensor 42, the location sensor 43, and the microphone 44 are provided for a wearable terminal 8 (refer to FIG. 3) such as a smart watch that the employee H0 wears. Second identification information is assigned to the wearable terminal 8 on a wearable terminal 8 basis. Then, the biometric sensor 42 measures the employee's H0 heart rate, body temperature, acceleration of his or her body region involved with his or her movement, breathing rate (which may be either a respiratory cycle or a respiratory rate per unit time), body fat percentage, basal metabolic rate, amount of activity, and oxygen level in the blood, for example, and transmits, along with the second identification information, the results of measurement as biometric information to the workload estimation system 2 intermittently (at regular intervals). The location sensor 43 detect the employee's H0 location by positioning technologies using radio wave information such as the global positioning system (GPS), or a beacon or Wi-Fi®, and transmits, along with the second identification information, the results of detection as location information to the workload estimation system 2 intermittently (at regular intervals). The microphone 44 picks up the speech uttered by the employee H0 and transmits, along with the second identification information, the result of speech picked up as speech information to the workload estimation system 2.

Optionally, the business assignment data collection system 4 may further include an image capture device installed in a building in which the company C1 is located, an office, or the building of the tenant. This allows the business assignment data collection system 4 to acquire the biometric information and location information about the plurality of employees H0 from captured images by subjecting the images captured by the image capture device installed in the building to image recognition processing.

In addition, the business assignment data collection system 4 may further include a fixed microphone installed in a building in which the company C1 is located, an office, or the building of the tenant. This allows the business assignment data collection system 4 to acquire the speech information about the plurality of employees H0 by subjecting the output of the fixed microphone installed in the building to speech recognition processing.

### (2.2) Workload Estimation System

The workload estimation system 2 includes the workload estimation unit 22 and the data output unit 23. The workload estimation system 2 preferably further includes a data management unit 21.

The workload estimation system 2 preferably includes a computer system. The functions of the workload estimation system 2 are performed either partially or entirely by making the computer system execute a program. The computer system includes, as a principal hardware component, a processor that operates in accordance with the program. Any type of processor may be used as long as the processor may perform the intended functions by executing the program. The processor may be made up of a single or a plurality of electronic circuits including a semiconductor integrated circuit (IC) or a large-scale integrated circuit (LSI). Although the electronic circuit is called an IC or an LSI, the electronic circuit may be called by a different name depending on the degree of integration thereof. Examples of other alternative electronic circuits include integrated circuits called a “system LSI,” a “very-large-scale integrated circuit (VLSI),” and an “ultra-large-scale integrated circuit (ULSI).” Optionally, a field-programmable gate array (FPGA) to be programmed after an LSI has been fabricated or a reconfigurable logic device allowing the connections or circuit sections inside of an LSI to be reconfigured may also be used for the same purpose. Those electronic circuits may be either integrated together on a single chip or distributed on multiple chips, whichever is appropriate. Those multiple chips may be aggregated together in a single device or distributed in multiple devices without limitation. The program may be stored in a non-transitory storage medium such as a ROM, an optical disc, or a hard disk drive, any of which is readable for a computer. The program may be stored in advance on a storage medium or downloaded via a wide area communications network such as the Internet and stored in the storage medium.

Note that the workload estimation system 2 may be implemented as either a single computer or multiple computers which are linked together, whichever is appropriate. Optionally, the workload estimation system 2 may also be implemented as a cloud computing system.

For example, the workload estimation system 2 is preferably a server device SV1 including a computer system. That is to say, the data management unit 21, the workload estimation unit 22, and the data output unit 23 are provided for the server device SV1. This allows the workload estimation system 2 to easily secure resources for processing the workload status.

### (2.2.1) Data Management Unit

The data management unit 21 stores the first identification information and second identification information and the identification information about the plurality of employees H0 in association with each other. This allows the data management unit 21 to associate, based on the first identification information and second identification information added to the business assignment data and human resources data received, the respective pieces of identification information about the plurality of employees H0 with their corresponding business assignment data and human resources data.

That is to say, the data management unit 21 stores the business assignment data and human resources data on an employee H0 basis.

### Business Assignment Data

The business assignment data stored in the data management unit 21 includes the terminal operating information, biometric information, location information, and speech information that the data management unit 21 has received from the business assignment data collection system 4.

### Human Resources Data

The human resources data stored in the data management unit 21 is data that a human resources department of the company C1 has transmitted to the workload estimation system 2. The human resources data includes at least one of work experience information, on-job-training information, performance evaluation information, attendance and absence information, or department information. In this embodiment, the human resources data includes the work experience information, the on-job-training information, the performance evaluation information, the attendance and absence information, and the department information.

The work experience information is information about the employee's H0 work experience. For example, the work experience information may be information about the employee's H0 work experience such as the history of the business assignments that he or her has been in charge of.

The on-job-training information is information about a history of on-job-training that the employee H0 has taken. For example, the on-job-training information may be information about the employee's H0 skills.

The performance evaluation information is information about the history of performance evaluation of the employee H0. For example, the performance evaluation information may be information about the evaluation made by a supervisor about the employee's H0 job performance.

The attendance and absence information is information about the attendance and absence of the employee H0. For example, the attendance and absence information may be information about the employee's H0 days off such as annual paid leaves and absence and about his or her working hours such as the beginning and end of his or her office hours.

The department information is information about the department of the company C1 to which the employee H0 currently belongs. For example, the department information may be information about the personnel that form the department to which the employee H0 belongs. The department information may be information about the relationship between supervisors and subordinates and information about coworkers as shown in the organization chart, for example.

### (2.2.2) Workload Estimation Unit

The workload estimation unit 22 estimates the workload status of the person H0 based on at least one of the business assignment data or the human resources data. In the following description, the employee H0 as the target of estimation is supposed to be an employee H1.

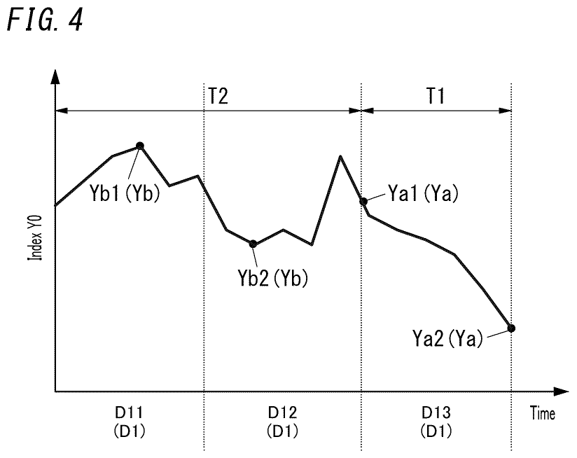

Specifically, the workload estimation unit 22 derives, based on at least one of the employee's H1 business assignment data or human resources data, an index Y0 (refer to FIG. 4) represented by a numerical value intermittently (at regular intervals) to generate the time series data of the index Y0. Then, the workload estimation unit 22 derives an evaluation value Ya based on the index Y0 to the evaluation period T1. The workload estimation unit 22 derives a reference value Yb based on the index Y0 to a reference period T2 including a period preceding the evaluation period T1. The workload estimation unit 22 estimates the employee's H1 workload status by comparing the evaluation value Ya with the reference value Yb.

As can be seen from the foregoing description, the workload estimation unit 22 may estimate the workload status on an employee H0 basis by using at least one of the business assignment data or the human resources data without requiring conducting a survey.

### Index Based on Business Assignment Data

Next, it will be described how the workload estimation unit 22 performs the processing of deriving the index Y0 based on the business assignment data. The workload estimation unit 22 derives, based on the business assignment data, the index Y0 (refer to FIG. 4) represented by a numerical value. The business assignment data includes the terminal operating information, the biometric information, the location information, and the speech information.

### Index Based on Terminal Operating Information

The workload estimation unit 22 may use, as the business assignment data, the terminal operating information about the terminal device 9 used by the employee H1. The terminal operating information is information about at least one selected from the group consisting of: operating a keyboard included in the terminal device 9; operating a mouse included in the terminal device 9; input of speech into a microphone included in the terminal device 9; an operation of a camera included in the terminal device 9; activation of an application to be executed by the terminal device 9; an operation of the application; the type of the application being executed on an active window; the type of the application activated; the number of the applications activated; and the number of windows opened by execution of the application. The workload estimation unit 22 may calculate, based on the terminal operating information, a total usage time on a daily basis. As used herein, the “total usage time” refers to the total amount of time for which the employee H1 uses the terminal device 9 per day. That is to say, the workload estimation unit 22 may acquire the time series data of the total usage time and use the numerical value representing the total usage time as the index Y0.

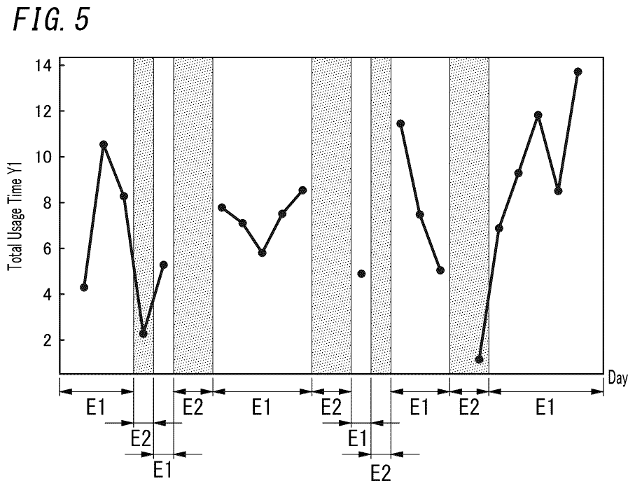

FIG. 5 shows, as an exemplary index Y0, the time series data of the total usage time Y1 of the terminal device 9 used by the employee H1. In FIG. 5, the abscissa indicates the day. Specifically, E1 indicates a weekday period and E2 indicates a day-off period (which may be Saturday, Sunday, or a holiday). In FIG. 5, the ordinate indicates the total usage time Y1.

### Index Based on Biometric Information

The workload estimation unit 22 may use, as the business assignment data, the biometric information about the employee H1. The biometric information includes information about the employee's H1 heart rate, the employee's H1 body temperature, and the acceleration of the employee's H1 body region involved with his or her movement. Thus, the workload estimation unit 22 may acquire, based on the biometric information, the time series data of the employee's H1 heart rate, body temperature, acceleration, and other parameters, and use the numerical values representing the heart rate, the body temperature, the acceleration, and other parameters as the index Y0.

In addition, the workload estimation unit 22 may also determine, based on at least one of the heart rate or the acceleration, whether the employee H1 is resting without making any movement. In that case, the workload estimation unit 22 may use, as the index Y0, the heart rate of the employee H1 in the resting state. Furthermore, the workload estimation unit 22 may exclude, from the index Y0, the data about the employee's H1 heart rate right after he or she has made a transition from the moving state to the resting state.

### Index Based on Location Information

The workload estimation unit 22 may use, as the business assignment data, the location information about the employee H1. The location information is information indicating the employee's H1 location. Thus, the workload estimation unit 22 may acquire, based on the location information, the time series data of the employee's H1 distance traveled, moving velocity, and other parameters and use numerical values representing the distance traveled, the moving velocity, and other parameters as the index Y0.

In addition, the workload estimation unit 22 may also determine, based on the location information, whether the employee H1 is resting without making any movement. In that case, the workload estimation unit 22 may use, as the index Y0, the heart rate of the employee H1 in the resting state. Furthermore, the workload estimation unit 22 may exclude, from the index Y0, the data about the employee's H1 heart rate right after he or she has made a transition from the moving state to the resting state.

### Index Based on Speech Information

The workload estimation unit 22 may also use, as the business assignment data, speech information about the employee H1. The speech information is information about the speech uttered by the employee H1. Thus, the workload estimation unit 22 may acquire, based on the speech information, the time series data of the volume of the speech uttered by the employee H1 and the number of times the employee H1 has uttered speech and may use numerical values representing the volume of the speech and the number of times of utterance as the index Y0.

### Estimation Based on Terminal Operating Information, Biometric Information, Location Information, and Speech Information

Optionally, the workload estimation unit 22 may derive the index Y0 using, in combination, at least two selected from the group consisting of the person's H1 terminal operating information, biometric information, location information, and speech information as the business assignment data.

### Index Based on Human Resources Data

Next, it will be described how the workload estimation unit 22 performs the processing of deriving the index Y0 based on the human resources data. The workload estimation unit 22 derives, based on the human resources data, an index Y0 (refer to FIG. 4) represented by a numerical value. The human resources data includes work experience information, on-job-training information, performance evaluation information, attendance and absence information, and department information.

### Index Based on Work Experience Information

The workload estimation unit 22 may use, as the human resources data, the work experience information about the employee H1. The work experience information is information about the history of the employee's H1 work experience. The workload estimation unit 22 may determine the degree of the employee's H1 business assignment suitability for the current business assignment by comparing, based on the work experience information, his or her current business assignment with the history of his or her work experience. That is to say, the workload estimation unit 22 may use a numerical value representing the degree of business assignment suitability as the index Y0.

### Index Based on On-Job-Training Information

The workload estimation unit 22 may also use, as the human resources data, the on-job-training information about the employee H1. The on-job-training information is information about the history of on-job-training that the employee H1 has taken so far. The workload estimation unit 22 may determine the degree of the employee's H1 business assignment suitability for the current business assignment by comparing, based on the on-job-training information, the employee's H1 current business assignment with the history of the on-job-training that he or she has taken so far. That is to say, the workload estimation unit 22 may use a numerical value representing the degree of business assignment suitability as the index Y0.

### Index Based on Performance Evaluation Information

The workload estimation unit 22 may also use, as the human resources data, the performance evaluation information about the employee H1. The performance evaluation information is information about the history of the employee's H1 performance evaluation. The workload estimation unit 22 may determine the degree of the employee's H1 business assignment suitability for the current business assignment by comparing, based on the performance evaluation information, the employee's H1 current business assignment with the history of the performance evaluation. That is to say, the workload estimation unit 22 may use a numerical value representing the degree of business assignment suitability as the index Y0.

### Index Based on Attendance and Absence Information

The workload estimation unit 22 may also use, as the human resources data, the attendance and absence information about the employee H1. The attendance and absence information is information about the history of the employee's H1 attendance and absence.

The workload estimation unit 22 may determine, based on the employee's H1 working hours derived from the attendance and absence information, his or her business assignment load. That is to say, the workload estimation unit 22 may use a numerical value representing the business assignment load as the index Y0.

In addition, the workload estimation unit 22 may also determine, based on the employee's H1 working hours derived from the attendance and absence information, the degree of support from other employees (H2-H4) for the employee's H1 business assignment. That is to say, the workload estimation unit 22 may use a numerical value representing the degree of support from other employees as the index Y0.

Furthermore, the workload estimation unit 22 may also find, based on the attendance and absence information, the interval from a point in time when the employee H1 leaves the office to a point in time when he or she reports to work next time. Then, the workload estimation unit 22 may determine, based on the interval from a point in time when the employee H1 leaves the office to a point in time when he or she reports to work next time, either his or her business assignment load or the degree of support from other employees. That is to say, the workload estimation unit 22 may use the numerical value representing either the business assignment load or the degree of support from other employees as the index Y0.

Furthermore, the workload estimation unit 22 may also find, based on the attendance and absence information, the rate at which the employee H1 has requested annual paid leaves. Then, the workload estimation unit 22 may determine, based on the rate at which the employee H1 has requested annual paid leaves, either his or her business assignment load or the degree of support from other employees. That is to say, the workload estimation unit 22 may use the numerical value representing either the business assignment load or the degree of support from other employees as the index Y0.

### Index Based on Department Information

The workload estimation unit 22 may also use, as the human resources data, department information about the employee H1. The department information is information about the first department C11 as a department of the company C1 to which the employee H0 belongs. The workload estimation unit 22 may find, based on the department information, the number of personnel that form the first department C11 to which the employee H1 belongs. That is to say, the workload estimation unit 22 may use a numerical value representing the number of personnel that form the first department C11 as the index Y0.

### Index Based on Work Experience Information, On-Job-Training Information, Performance Evaluation Information, Attendance and Absence Information, and Department Information

Optionally, the workload estimation unit 22 may derive the index Y0 by using, in combination, at least two selected from the group consisting of the employee's H1 work experience information, on-job-training information, performance evaluation information, attendance and absence information, and department information as the human resources data.

### Index Based on Business Assignment Data and Human Resources Data

The workload estimation unit 22 may derive the index Y0 by using, in combination, the business assignment data and the human resources data.

For example, the workload estimation unit 22 may use the location information and speech information about the employees H1-H4 as the business assignment data and use the department information about the employees H1-H4 as the human resources data. In that case, the workload estimation unit 22 may determine, based on respective piece of the location information about the employees H1-H4, the length of the time for which the employees H1-H4 have approached each other (hereinafter referred to as an “approach time”) and the number of times that employees H1-H4 have approached each other (hereinafter referred to as the “number of times of approach”). In addition, the workload estimation unit 22 may also determine, based on respective pieces of the speech information about the employees H1-H4, whether the employees H1-H4 communicated with each other when they approached each other. Furthermore, the workload estimation unit 22 may further determine, based on respective pieces of the work experience information and department information about the employees H1-H4, the mutual relationship between the employees H1-H4 (e.g., whether the employees H1-H4 have supervisor-subordinate relationship or whether they are in charge of the same business assignment). Then, the workload estimation unit 22 may derive, based on these decisions, either the number of times or the quantity (indicating the degree of cooperation in business assignment) of mutual communication between the employees H1-H4 as the index Y0.

### Estimation of Workload Status

The workload estimation unit 22 estimates the employee's H1 workload status based on the index Y0.

Specifically, as shown in FIG. 4, the workload estimation unit 22 derives the evaluation value Ya based on the index Y0 to the evaluation period T1. The workload estimation unit 22 derives the reference value Yb based on the index Y0 to a reference period T2 including a period preceding the evaluation period T1. The workload estimation unit 22 estimates the employee's H1 workload status by comparing the evaluation value Ya with the reference value Yb.

In this embodiment, the workload estimation unit 22 sections the work on the basis of a unit period D1 (one day) from 0 o'clock through 24 o'clock. In FIG. 4, the day D11 before yesterday, yesterday D12, and today D13 are shown as the respective unit periods D1 and the time series data of the index Y0 to the three days, namely, the day D11 before yesterday, yesterday D12, and today D13, are shown.

Then, the workload estimation unit 22 sets, as the evaluation period T1, today D13 out of the day D11 before yesterday, yesterday D12, and today D13. This evaluation period T1 includes today D13 that is the latest unit period D1 out of the day D11 before yesterday, yesterday D12, and today D13 that are a plurality of unit periods D1. In FIG. 4, the evaluation period T1 is supposed to be today D13. That is to say, the workload estimation unit 22 makes real-time estimation of estimating the employee's H1 workload either at present or for today by setting the evaluation period T1 as today D13 that is the latest unit period D1.

Next, the workload estimation unit 22 derives an evaluation value Ya based on the index Y0 to the evaluation period T1 (today D13). The evaluation value Ya is preferably a maximum value, a minimum value, a median, a dispersion, an average value, or a moving average value of the index Y0 to the evaluation period T1. For example, if the maximum value of the index Y0 to the evaluation period T1 is supposed to be the evaluation value Ya, then the evaluation value Ya will be Ya1 (refer to FIG. 4). On the other hand, if the minimum value of the index Y0 to the evaluation period T1 is supposed to be the evaluation value Ya, then the evaluation value Ya will be Ya2 (refer to FIG. 4). Thus, the workload estimation unit 22 may derive the evaluation value Ya easily based on the index Y0.

In addition, the workload estimation unit 22 sets, as the reference period T2, the day D11 before yesterday and yesterday D12 out of the day D11 before yesterday, yesterday D12, and today D13. This reference period T2 includes a period preceding the evaluation period T1. Then, the workload estimation unit 22 derives the reference value Yb based on the index Y0 to the reference period T2 (including the day D11 before yesterday and yesterday D12). The reference value Yb is preferably a maximum value, a minimum value, a median, a dispersion, an average value, or a moving average value of the index Y0 to the reference period T2. For example, if the maximum value of the index Y0 to the reference period T2 is supposed to be the reference value Yb, then the reference value Yb will be Yb1 (refer to FIG. 4). On the other hand, if the minimum value of the index Y0 to the reference period T2 is supposed to be the reference value Yb, then the reference value Yb will be Yb2 (refer to FIG. 4). Thus, the workload estimation unit 22 may derive the reference value Yb easily based on the index Y0.

Then, the workload estimation unit 22 estimates the workload status by comparing the evaluation value Ya with the reference value Yb.

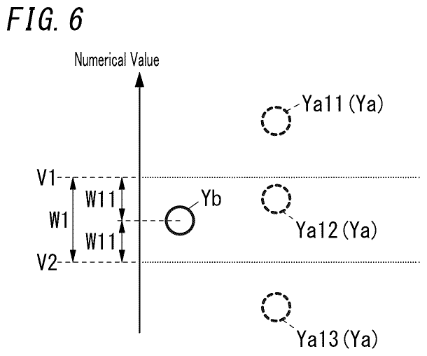

Specifically, when finding the evaluation value Ya falling within a reference range W1 as shown in FIG. 6, the workload estimation unit 22 estimates that the workload has not changed. On the other hand, when finding the evaluation value Ya falling outside of the reference range W1, the workload estimation unit 22 estimates that the workload has changed. As used herein, the “reference range W1” refers to a range including the reference value Yb. For example, the reference range W1 may be a range with a width of ±W11 with respect to the reference value Yb. Note that the reference range W1 only needs to be a range including the reference value Yb and may also be, for example, either a predetermined range equal to or greater than the reference value Yb or a predetermined range equal to or less than the reference value Yb, whichever is appropriate.

Then, when finding the evaluation value Ya to be an evaluation value Ya11 greater than an upper limit value V1 of the reference range W1, the workload estimation unit 22 estimates that the employee's H1 workload has changed toward a heavy load range (i.e., his or her workload has increased). On the other hand, when finding the evaluation value Ya to be an evaluation value Ya13 less than a lower limit value V2 of the reference range W1, the workload estimation unit 22 estimates that the employee's H1 workload has changed toward a light load range (i.e., his or her workload has decreased). Furthermore, when finding the evaluation value Ya to be an evaluation value Ya12 falling within the reference range W1, the workload estimation unit 22 estimates that the employee's H1 workload has not changed.

As can be seen from the foregoing description, the workload estimation unit 22 may easily determine, by comparing the evaluation value Ya with the reference value Yb, whether the employee's H1 workload has changed or not.

### (2.2.3) Data Output Unit

The data output unit 23 outputs estimation data, including a result of estimation made by the workload estimation unit 22 about the workload status, to the display device 3. The data output unit 23 generates the estimation data as image data. The data output unit 23 may further add audio data to the estimation data.

### (2.3) Display Device

The display device 3 may be, for example, a tablet computer, a smartphone, a liquid crystal display device, or an organic EL display device used by the employee H1 and includes a screen on which an image is displayed. Then, the display device 3 displays, on the screen, the estimation data that the display device 3 has received from the data output unit 23. Also, if the estimation data includes audio data, the display device 3 emits audio (such as a voice) from a loudspeaker.

### (3) First Variation

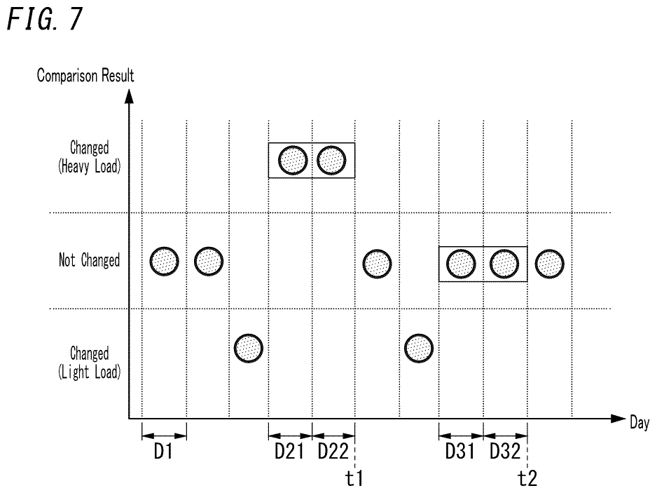

In a first variation, every time a new unit period D1 (i.e., the latest unit period D1) is added, the workload estimation unit 22 performs the processing of comparing the evaluation value Ya of the new unit period D1 with the reference range W1. Then, the workload estimation unit 22 stores the results of comparison on a unit period D1 basis as shown in FIG. 7. In FIG. 7, if the evaluation value Ya of the unit period D1 falls within the reference range W1, the comparison result is indicated as “Not Changed.” On the other hand, if the evaluation value Ya is greater than the upper limit value of the reference range W1, then the comparison result is indicated as “Changed (Heavy Load).” Furthermore, if the evaluation value Ya is less than the upper limit value of the reference range W1, then the comparison result is indicated as “Changed (Light Load).” Note that the reference range W1 for use in the comparison processing in each of the plurality of unit periods D1 is a range defined based on the reference period T2 corresponding to the unit period D1, not common for every unit period D1.

Then, the workload estimation unit 22 preferably estimates the workload status based on at least one of the frequency of occurrence of the comparison result “Not Changed” or the frequency of occurrence of the comparison result “Changed (Heavy Load)” and “Changed (Light Load).” That is to say, the workload estimation unit 22 preferably estimates the workload status based on at least one of the frequency of occurrence of the state where the evaluation value Ya falls within the reference range W1 or the frequency of occurrence of the state where the evaluation value Ya falls outside of the reference range W1.

In this variation, the workload estimation unit 22 estimates the workload status based on the frequency of occurrence of the comparison result “Not Changed,” the frequency of occurrence of the comparison result “Changed (Heavy Load),” and the frequency of occurrence of the comparison result “Changed (Light Load).”

Specifically, when finding the number of times the same comparison result has been obtained consecutively equal to or greater than a threshold number of times (e.g., twice), the workload estimation unit 22 updates the estimation result. In FIG. 7, in the unit periods D21 and D22, the same comparison result “Changed (Heavy Load)” has been obtained twice consecutively. That is to say, in the unit periods D21 and D22, the number of times the state where the evaluation value Ya is greater than the upper limit value V1 of the reference range W1 has been produced consecutively is equal to or greater than the threshold number of times (twice). Thus, the workload estimation unit 22 estimates, at a time t1 immediately after the unit period D22, that the workload is in heavy load status.

Also, in FIG. 7, in the unit periods D31 and D32, the comparison result “Not Changed” has been obtained twice consecutively. That is to say, in the unit periods D31 and D32, the number of times the state where the evaluation value Ya falls within the reference range W1 has been produced consecutively is equal to or greater than the threshold number of times (twice). Thus, the workload estimation unit 22 estimates, at a time t2 immediately after the unit period D32, that the workload is in steady status.

The workload estimation unit 22 according to this variation may easily estimate the employee's H0 workload status.

### (4) Second Variation

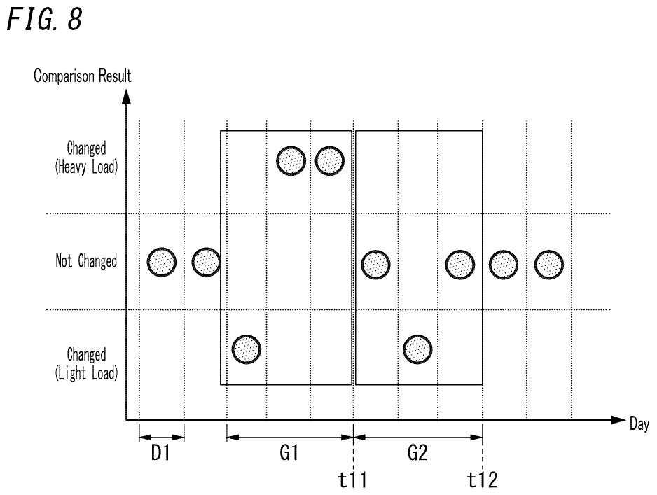

In a second variation, every time a new unit period D1 (i.e., the latest unit period D1) is added, the workload estimation unit 22 performs the processing of comparing the evaluation value Ya of the new unit period D1 with the reference range W1. Then, the workload estimation unit 22 stores the results of comparison on a unit period D1 basis as shown in FIG. 8. In FIG. 8, if the evaluation value Ya of the unit period D1 falls within the reference range W1, the comparison result is indicated as “Not Changed.” On the other hand, if the evaluation value Ya is greater than the upper limit value of the reference range W1, then the comparison result is indicated as “Changed (Heavy Load).” Furthermore, if the evaluation value Ya is less than the upper limit value of the reference range W1, then the comparison result is indicated as “Changed (Light Load).” Note that the reference range W1 for use in the comparison processing in each of the plurality of unit periods D1 is a range defined based on the reference period T2 corresponding to the unit period D1, not common for every unit period D1.

Then, the workload estimation unit 22 preferably estimates the workload status based on at least one of the frequency of occurrence of the comparison result “Not Changed” or the frequency of occurrence of the comparison result “Changed (Heavy Load)” and the frequency of occurrence of the comparison result “Changed (Light Load).” That is to say, the workload estimation unit 22 preferably estimates the workload status based on at least one of the frequency of occurrence of the state where the evaluation value Ya falls within the reference range W1 or the frequency of occurrence of the state where the evaluation value Ya falls outside of the reference range W1.

In this variation, the workload estimation unit 22 estimates the workload status based on the frequency of occurrence of the comparison result “Not Changed,” the frequency of occurrence of the comparison result “Changed (Heavy Load),” and the frequency of occurrence of the comparison result “Changed (Light Load).”

Specifically, the workload estimation unit 22 forms a group consisting of three continuous unit periods D1 and performs statistical processing on the respective comparison results of the three unit periods D1 on a group-by-group basis. In FIG. 8, the workload estimation unit 22 performs the statistical processing on each of the two groups G1, G2, each consisting of three continuous unit periods D1.

As for the group G1, the comparison results of the three unit periods D1 are “Changed (Light Load),” “Changed (Heavy Load),” and “Changed (Heavy Load),” and therefore, the event probability of “Changed (Heavy Load)” is the highest. Thus, the workload estimation unit 22 estimates, at a time t11 immediately after the group G1, that the workload is in heavy load status.

As for the group G2, the comparison results of the three unit periods D1 are “Not Changed,” “Changed (Light Load),” and “Not Changed,” and therefore, the event probability of “Not Changed” is the highest. Thus, the workload estimation unit 22 estimates, at a time t12 immediately after the group G2, that the workload is in steady status.

The workload estimation unit 22 according to this variation may easily estimate the employee's H0 workload status.

### (5) Third Variation

In this variation, the workload estimation unit 22 estimates the workload status by reference to an inflection point generated on the time series data of the index Y0.

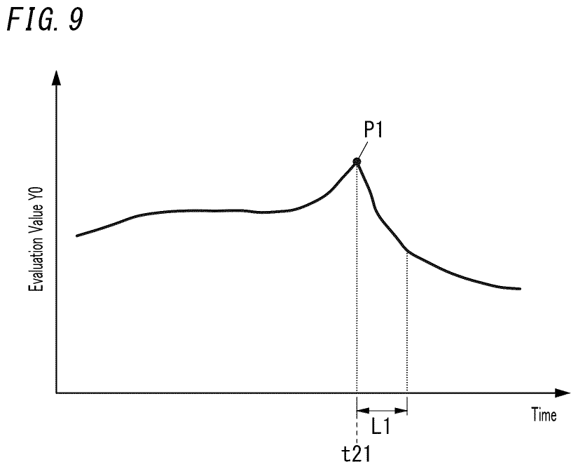

Specifically, the workload estimation unit 22 extracts an inflection point P1 from the time series data of the index Y0 to the employee H1 as shown in FIG. 9. Then, when finding that the index Y0 continues to decrease for a time threshold value L1 from a timing t21 when the inflection point P1 is generated as shown in FIG. 9, the workload estimation unit 22 estimates that the employee's H1 workload has changed toward the light load range (i.e., his or her workload has decreased). On the other hand, when finding that the index Y0 continues to increase for the time threshold value L1 from the timing t21 when the inflection point P1 is generated, the workload estimation unit 22 estimates that the employee's H1 workload has changed toward the heavy load range (i.e., his or her workload has increased).

The workload estimation unit 22 according to this variation may easily estimate the employee's H0 workload status.

### (6) Fourth Variation

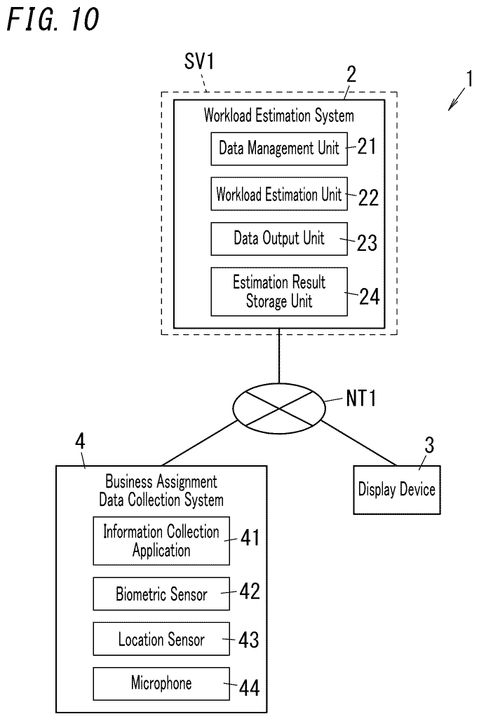

The workload estimation system 2 shown in FIG. 10 further includes an estimation result storage unit 24. The estimation result storage unit 24 stores the estimation results of workload statuses of a plurality of employees H0. The data output unit 23 determines, in advance with respect to every destination to which the estimation data is to be output, at least one estimation result belonging to the plurality of the workload status estimation results of the plurality of employees H0 which may be included in the estimation data.

Specifically, the workload estimation unit 22 estimates the respective workload statuses of the plurality of employees H0 as well as for the employee H1. Then, the workload estimation unit 22 saves the respective estimation results about the plurality of employees H0 in the estimation result storage unit 24.

For example, suppose an employee H2 is a manager (or section head) of the first department C11, to which a plurality of employees H0, including the employee H1, belong as subordinates of the employee H2. In that case, if the display device 3 as a destination to which the estimation data is to be output is the display device 3 used by the employee H2, then the data output unit 23 may have not only the estimation result about the employee H2 but also the respective estimation results about the plurality of employees H1 belonging to the first department C11 included in the estimation data. On the other hand, if the display device 3 as a destination to which the estimation data is to be output is the display device 3 used by the employee H1, then the data output unit 23 may have the estimation result about the employee's H1 workload included in the estimation data but cannot have the estimation results about the workloads of the employees H0, other than the employee H1, included in the estimation data.

In addition, an average of the estimation results of the respective workloads of all employees H0 (including the employees H1 and H2) belonging to the first department C11 is used as the estimation result about the workload status of the first department C11. In that case, if the display device 3 as a destination to which the estimation data is to be output is the display device 3 used by an employee H0 belonging to the first department C11, then the data output unit 23 may have the estimation result about the first department C11 included in the estimation data.

The workload estimation system 2 according to this variation determines, in advance with respect to each destination to which the estimation data is to be output, the estimation result which may be output, thus enabling protecting the personal information about the employees H0.

### (7) Fifth Variation

The workload estimation unit 22 sets a past period as the evaluation period T1, thereby making past estimation of estimating the employee's H1 workload status either in the past or for a day before yesterday, instead of making the real-time estimation of estimating the employee's H1 workload status either at present or for today.

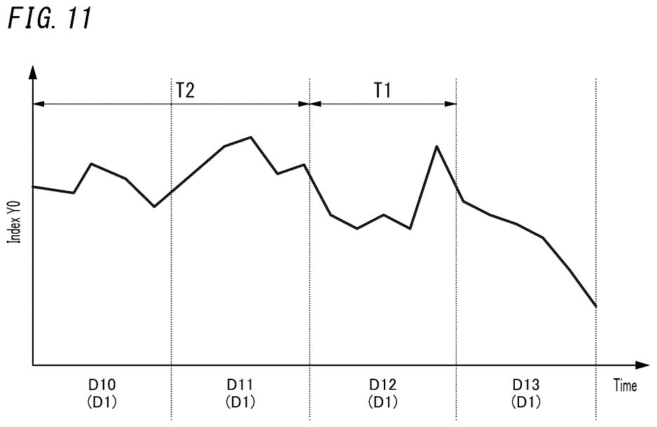

Specifically, the workload estimation unit 22 defines a unit period D1 (one day) to be a period from 0 o'clock through 24 o'clock as shown in FIG. 11. In FIG. 11, the day D10 before the day D11 before yesterday, the day D11 before yesterday, yesterday D12, and today D13 are shown as exemplary unit periods D1 and the time series data of the index Y0 to these four days, namely, the day D10 before the day D11 before yesterday, the day D11 before yesterday, yesterday D12, and today D13 are shown.

Then, the workload estimation unit 22 sets, as the evaluation period T1, yesterday D12 out of the day D10 before the day D11 before yesterday, the day D11 before yesterday, yesterday D12, and today D13. This evaluation period T1 does not include today D13 as the latest unit period D1 out of the day D10 before the day D11 before yesterday, the day D11 before yesterday, yesterday D12, and today D13 that are the plurality of unit periods D1. That is to say, the workload estimation unit 22 makes past estimation of estimating the employee's H1 workload either in the past or for a day before yesterday by excluding today D13 as the latest unit period D1 from the evaluation period T1.

Next, the workload estimation unit 22 derives an evaluation value Ya based on the index Y0 to the evaluation period T1 (yesterday D12). The evaluation value Ya is preferably a maximum value, a minimum value, a median, a dispersion, an average value, or a moving average value of the index Y0 to the evaluation period T1.

In addition, the workload estimation unit 22 sets, as the reference period T2, the day D10 before the day D11 before yesterday and the day D11 before yesterday out of the day D10 before the day D11 before yesterday, the day D11 before yesterday, yesterday D12, and today D13. This reference period T2 includes a period preceding the evaluation period T1. Then, the workload estimation unit 22 derives the reference value Yb based on the index Y0 to the reference period T2 (including the day D10 before the day D11 before yesterday and the day D11 before yesterday). The reference value Yb is preferably a maximum value, a minimum value, a median, a dispersion, an average value, or a moving average value of the index Y0 to the reference period T2.

Then, the workload estimation unit 22 estimates the workload status by comparing the evaluation value Ya with the reference value Yb.

### (8) Sixth Variation

The unit period D1 is preferably set for the employee's H0 weekdays, not for the employee's H0 days off.

Specifically, when using, as the index Y0, the total usage time Y1 shown in FIG. 5, the workload estimation unit 22 extracts the total usage time Y1 of the weekday periods E1 and does not extract the total usage time Y1 of the days off E2 (including Saturdays, Sundays, holidays, and annual paid leaves (including half day off and hours off)). Then, the workload estimation unit 22 estimates the workload status based on the total usage time Y1 of the weekday periods E1. For example, the workload estimation unit 22 may obtain an evaluation value Ya and a reference value Yb by setting the evaluation period T1 and the reference period T2 with respect to the time series data of the total usage time Y1 of the weekday periods E1. Optionally, the workload estimation unit 22 may extract an inflection point from the time series data of the total usage time Y1 of the weekday periods E1.

The workload estimation unit 22 according to this variation may estimate the workload status for weekdays.

### (9) Seventh Variation

The workload estimation system 2 preferably estimates the workload status using not only the business assignment data and the human resources data but also answer data as well.

As used herein, the “answer data” refers to data collected by carrying out a survey (including a questionnaire) on the employees H0 to learn what the employees H0 think about their labor situation. That is to say, the answer data is data about the employees'H0 answers to the questions posed in the survey.

Then, the data management unit 21 saves not only the business assignment data and the human resources data but also the answer data as well. The workload estimation unit 22 estimates the workload status based on the answer data and at least one of the business assignment data or the human resources data.

For example, if the estimation result based on at least one of the business assignment data or the human resources data indicates that the workload has increased, a survey is conducted to ask the employee H0 him- or herself about his or her labor situation and the answer data thus collected is saved in the data management unit 21. Then, the workload estimation unit 22 determines, based on the answer data, the employee's H0 optimism and resilience and re-estimates his or her workload status with his or her optimism and resilience taken into account.

The workload estimation unit 22 according to this variation may estimate the employee's H0 workload status even more accurately by using not only the business assignment data and the human resources data but also the answer data as well.

### (10) Eighth Variation

The workload estimation unit 22 preferably enters at least one of the business assignment data or human resources data into a learned model established by machine learning to acquire an estimation result about the workload status from the learned model.

Specifically, the employee H0 creates, as self-evaluation data, his or her evaluation with respect to the workload in the evaluation period T1. Then, the employee H0 uses, as training data, the estimation data including the estimation result obtained by the workload estimation unit 22 about the workload in the evaluation period T1 and the self-evaluation data created by the employee H0 him- or herself to enter the training data into a learned model creation system. The learned model creation system stores the learned model to be used by the workload estimation unit 22 and performs, by learning using the training data, learning processing of establishing or re-establishing an algorithm for the learned model. That is to say, the learned model creation system creates a learned model and improves the learned model by machine learning. The learned model thus created and improved by the learned model creation system is loaded as appropriate into the workload estimation unit 22.

The learned model is preferably established by machine learning such as deep learning using a neural network but should not be limited to any particular model.

The workload estimation unit 22 may estimate the workload status even more accurately by using a learned model.

### (11) Ninth Variation

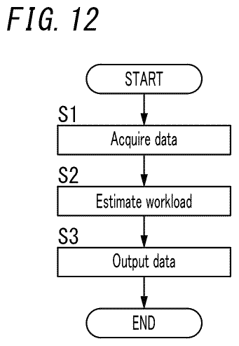

The workload estimation method to be performed by the workload estimation system 2 described above may be summarized by the flowchart shown in FIG. 12.

The workload estimation method includes a data acquiring step S1, a workload estimating step S2, and a data outputting step S3.

The data acquiring step S1 includes making the data management unit 21 acquire at least one of the business assignment data or the human resources data (and the answer data if necessary).

The workload estimating step S2 includes making the workload estimation unit 22 estimate the workload status based on at least one of the business assignment data or the human resources data (and the answer data if necessary).

The data outputting step S3 includes making the data output unit 23 output estimation data, including the estimation result about the workload status, to the display device 3.

This workload estimation method allows the workload status to be estimated on an employee H0 basis by using at least one of the business assignment data or the human resources data without requiring conducting a survey.

### (12) Tenth Variation

The workload estimation system 2 does not have to use both the business assignment data and the human resources data but may estimate the workload status using at least one of the business assignment data or the human resources data.

The business assignment data may include additional information other than the terminal operating information, the biometric information, the location information, and the speech information. The biometric information may include additional information other than information about the employee's H0 heart rate, his or her body temperature, and acceleration of his or her body region involved with his or her movement.

The human resources data may include additional information other than the work experience information, the on-job-training information, the performance evaluation information, the attendance and absence information, and the department information.

The evaluation period T1 may include a plurality of unit periods D1.

The reference period T2 may include today D13 as the latest unit period D1.

The data management unit 21 may be provided for a system or apparatus other than the workload estimation system 2.

### (13) Recapitulation

A workload estimation system (2) according to a first aspect of the exemplary embodiment estimates a workload status indicating a degree of load placed by work on a person (H0). The workload estimation system (2) includes a workload estimation unit (22) and a data output unit (23). The workload estimation unit (22) estimates the workload status based on at least one of business assignment data about a history of business assignments that have been performed by the person (H0) or human resources data about human resources of the person (H0). The data output unit (23) outputs estimation data including an estimation result about the workload status.

This workload estimation system (2) may estimate the workload status on a person (H0) basis without requiring conducting a survey.

In a workload estimation system (2) according to a second aspect of the exemplary embodiment, which may be implemented in conjunction with the first aspect, the business assignment data preferably includes at least one selected from the group consisting of: terminal operating information about an operation performed by the person (H0) on a terminal device (9); biometric information about the person (H0); location information about the person (H0); and speech information about a speech uttered by the person (H0).

This workload estimation system (2) may use business assignment data which allows the workload status to be estimated.

In a workload estimation system (2) according to a third aspect of the exemplary embodiment, which may be implemented in conjunction with the second aspect, the terminal operating information is preferably information about at least one selected from the group consisting of: operating a keyboard included in the terminal device (9); operating a mouse included in the terminal device (9); input of speech into a microphone included in the terminal device (9); an operation of a camera included in the terminal device (9); activation of an application to be executed by the terminal device (9); an operation of the application; a type of the application being executed on an active window; a type of the application activated; a numerical number of the applications activated; and a numerical number of windows opened by execution of the application.

This workload estimation system (2) may use terminal operating information which allows the workload status to be estimated.

In a workload estimation system (2) according to a fourth aspect of the exemplary embodiment, which may be implemented in conjunction with the second or third aspect, the biometric information is preferably information about at least one selected from the group consisting of: a heart rate of the person (H0); a body temperature of the person (H0); and acceleration of a body region of the person (H0) involved with movement of the person (H0).

This workload estimation system (2) may use biometric information which allows the workload status to be estimated.

In a workload estimation system (2) according to a fifth aspect of the exemplary embodiment, which may be implemented in conjunction with any one of the first to fourth aspects, the human resources data preferably includes at least one selected from the group consisting of: work experience information about work experience of the person (H0); on-job-training information about a history of on-job-training that the person (H0) has taken; performance evaluation information about a history of performance evaluation of the person (H0); attendance and absence information about attendance and absence of the person (H0); and department information about a department to which the person (H0) belongs.

This workload estimation system (2) may use human resources data which allows the workload status to be estimated.

In a workload estimation system (2) according to a sixth aspect of the exemplary embodiment, which may be implemented in conjunction with any one of the first to fifth aspects, the workload estimation unit (22) preferably derives an index (Y0) represented by a numerical value based on at least one of the business assignment data or the human resources data. The workload estimation unit (22) derives an evaluation value (Ya) based on the index (Y0) to an evaluation period (T1) and derives a reference value (Yb) based on the index (Y0) to a reference period (T2) including a period preceding the evaluation period (T1). The workload estimation unit (22) estimates the workload status by comparing the evaluation value (Ya) with the reference value (Yb).

This workload estimation system (2) may estimate the workload status on an employee (H0) basis using at least one of the business assignment data or the human resources data without requiring conducting a survey.

In a workload estimation system (2) according to a seventh aspect of the exemplary embodiment, which may be implemented in conjunction with the sixth aspect, the evaluation value (Ya) is preferably a maximum value (Ya1), a minimum value (Ya2), a median, a dispersion, an average value, or a moving average value of the index (Y0) to the evaluation period (T1). The reference value (Yb) is preferably a maximum value (Yb1), a minimum value (Yb2), a median, a dispersion, an average value, or a moving average value of the index (Y0) to the reference period (T2).

This workload estimation system (2) may derive the evaluation value (Ya) easily based on the index (Y0).

In a workload estimation system (2) according to an eighth aspect of the exemplary embodiment, which may be implemented in conjunction with the sixth or seventh aspect, the work is preferably sectioned on a unit period (D1) basis into a plurality of unit periods (D1). The evaluation period (T1) preferably includes the latest unit period (D13) out of the plurality of unit periods (D1).

This workload estimation system (2) may make real-time estimation of estimating the workload placed on the person (H0) either at present or for today.

In a workload estimation system (2) according to a ninth aspect of the exemplary embodiment, which may be implemented in conjunction with the sixth or seventh aspect, the work is preferably sectioned on a unit period (D1) basis into a plurality of unit periods (D1). The evaluation period (T1) preferably excludes the latest unit period (D13) out of the plurality of unit periods (D1).

This workload estimation system (2) may make past estimation of estimating the workload placed on the person (H0) either in the past or for a day before yesterday.

In a workload estimation system (2) according to a tenth aspect of the exemplary embodiment, which may be implemented in conjunction with the eighth or ninth aspect, the plurality of unit periods (D1) are preferably set with respect to weekdays (E1) for the person (H0), not with respect to days off (E2) for the person (H0).

This workload estimation system (2) may estimate the workload status for weekdays.

In a workload estimation system (2) according to an eleventh aspect of the exemplary embodiment, which may be implemented in conjunction with any one of the sixth to tenth aspects, when the evaluation value (Ya) falls within a reference range (W1) including the reference value (Yb), the workload estimation unit (22) preferably estimates that the workload has not changed. On the other hand, when the evaluation value (Ya) falls outside of the reference range (W1), the workload estimation unit (22) preferably estimates that the workload has changed.

This workload estimation system (2) may easily determine whether the workload placed on the person (H0) has changed or not.

In a workload estimation system (2) according to a twelfth aspect of the exemplary embodiment, which may be implemented in conjunction with any one of the sixth to tenth aspects, the workload estimation unit (22) preferably estimates the workload status based on at least one of a frequency of occurrence of a state where the evaluation value (Ya) falls within the reference range (W1) including the reference value (Yb) or a frequency of occurrence of a state where the evaluation value (Ya) falls outside of the reference range (W1).

This workload estimation system (2) may easily estimate the workload status of the person (H0).

In a workload estimation system (2) according to a thirteenth aspect of the exemplary embodiment, which may be implemented in conjunction with any one of the first to fifth aspects, the workload estimation unit (22) preferably derives, based on at least one of the business assignment data or the human resources data, an index (Y0) represented by a numerical value. The workload estimation unit (22) preferably estimates the workload status by reference to an inflection point (P1) generated in time series data of the index (Y0).

This workload estimation system (2) may easily estimate the workload status of the person (H0).

In a workload estimation system (2) according to a fourteenth aspect of the exemplary embodiment, which may be implemented in conjunction with the thirteenth aspect, when finding a duration, for which the index (Y0) continues to increase or decrease since the inflection point (P1) has been generated, equal to or greater than a time threshold value (L1), the workload estimation unit (22) preferably estimates that the workload has changed.

This workload estimation system (2) may easily estimate the workload status of the person (H0).

A workload estimation system (2) according to a fifteenth aspect of the exemplary embodiment, which may be implemented in conjunction with any one of the first to fourteenth aspects, preferably further includes an estimation result storage unit (24) that stores the estimation result with respect to each of a plurality of the persons (H0). The data output unit (23) determines, in advance with respect to every destination to which the estimation data is to be output, at least one estimation result belonging to a plurality of the estimation results which may be included in the estimation data.

This workload estimation system (2) may protect the personal information about the person (H0).

In a workload estimation system (2) according to a sixteenth aspect of the exemplary embodiment, which may be implemented in conjunction with the fifteenth aspect, the workload estimation unit (22) and the data output unit (23) are preferably provided for a server device (SV1).

This workload estimation system (2) may easily secure resources for use to process the workload status.

In a workload estimation system (2) according to a seventeenth aspect of the exemplary embodiment, which may be implemented in conjunction with any one of the first to sixteenth aspects, the workload estimation unit (22) preferably estimates the workload status based on at least one of the business assignment data or the human resources data and answer data about the person's (H0) answer to a question.

This workload estimation system (2) may estimate the workload status even more accurately by using not only the business assignment data and the human resources data but also answer data as well.

In a workload estimation system (2) according to an eighteenth aspect of the exemplary embodiment, which may be implemented in conjunction with any one of the first to seventeenth aspects, the workload estimation unit (22) preferably enters at least one of the business assignment data or the human resources data into a learned model established by machine learning and acquires the estimation result from the learned model.

This workload estimation system (2) may estimate the workload status more accurately by using a learned model.

A workload estimation system (2) according to a nineteenth aspect of the exemplary embodiment, which may be implemented in conjunction with any one of the first to eighteenth aspects, preferably further includes a data management unit (21) that saves at least one of the business assignment data or the human resources data.

This workload estimation system (2) may manage at least one of the business assignment data or the human resources data.

A workload management system (1) according to a twentieth aspect of the exemplary embodiment includes: the workload estimation system (2) according to any one of the first to nineteenth aspects; and a display device (3) that displays the estimation data.

This workload management system (1) may estimate the workload status on a person (H0) basis without requiring conducting a survey.

A workload estimation method according to a twenty-first aspect of the exemplary embodiment is designed to be performed by a workload estimation system (2) for estimating a workload status indicating a degree of load placed by work on a person (H0). The workload estimation method includes a workload estimating step (S2) and a data outputting step (S3). The workload estimating step (S2) includes estimating the workload status based on at least one of business assignment data about a history of business assignments that have been performed by the person (H0) or human resources data about human resources of the person (H0). The data outputting step (S3) includes outputting estimation data including an estimation result about the workload status.

This workload estimation method enables estimating the workload status on a person (H0) basis without requiring conducting a survey.

A program according to a twenty-second aspect of the exemplary embodiment is designed to cause a computer system to perform the workload estimation method according to the twenty-first aspect.

This program enables estimating the workload status on a person (H0) basis without requiring conducting a survey.

### REFERENCE SIGNS LIST

1 Workload Management System
2 Workload Estimation System
21 Data Management Unit
22 Workload Estimation Unit
23 Data Output Unit
24 Estimation Result Storage Unit
3 Display Device
9 Terminal Device
H0 (H1, H2, . . . ) Employee (Person)
SV1 Server Device
Y0 Index
Ya Evaluation Value
Ya1 Maximum Value of Index
Ya2 Minimum Value of Index
Yb Reference Value
Yb1 Maximum Value of Index
Yb2 Minimum Value of Index
T1 Evaluation Period
T2 Reference Period
D1 Unit Period
D13 Today (Latest Unit Period)
E1 Weekday Period
E2 Day-Off Period
W1 Reference Range
P1 Inflection Point
L1 Time Threshold Value
S2 Workload Estimating Step
S3 Data Outputting Step

1. A workload estimation system configured to estimate a workload status indicating a degree of load placed by work on a person, the workload estimation system comprising:
a workload estimation unit configured to estimate the workload status based on at least one of business assignment data about a history of business assignments that have been performed by the person or human resources data about human resources of the person; and
a data output unit configured to output estimation data including an estimation result about the workload status,
the workload estimation unit being configured to:
derive, based on at least one of the business assignment data or the human resources data, an index represented by a numerical value; and
estimate the workload status by reference to an inflection point generated in time series data of the index.

2. The workload estimation system of claim 1, wherein
the business assignment data includes at least one selected from the group consisting of: terminal operating information about an operation performed by the person on a terminal device; biometric information about the person; location information about the person; and speech information about a speech uttered by the person.

3. The workload estimation system of claim 2, wherein
the terminal operating information is information about at least one selected from the group consisting of: operating a keyboard included in the terminal device; operating a mouse included in the terminal device; input of speech into a microphone included in the terminal device; an operation of a camera included in the terminal device; activation of an application to be executed by the terminal device; an operation of the application; a type of the application being executed on an active window; a type of the application activated; a numerical number of the applications activated; and a numerical number of windows opened by execution of the application.

4. The workload estimation system of claim 2, wherein
the biometric information is information about at least one selected from the group consisting of: a heart rate of the person; a body temperature of the person; and acceleration of a body region of the person involved with movement of the person.

5. The workload estimation system of claim 1, wherein
the human resources data includes at least one selected from the group consisting of: work experience information about work experience of the person; on-job-training information about a history of on-job-training that the person has taken; performance evaluation information about a history of performance evaluation of the person; attendance and absence information about attendance and absence of the person; and department information about a department to which the person belongs.

6. The workload estimation system of claim 1, wherein
the workload estimation unit is configured to:
derive an index represented by a numerical value based on at least one of the business assignment data or the human resources data;
derive an evaluation value based on the index to an evaluation period;
derive a reference value based on the index to a reference period including a period preceding the evaluation period; and
estimate the workload status by comparing the evaluation value with the reference value.

7. The workload estimation system of claim 6, wherein
the evaluation value is a maximum value, a minimum value, a median, a dispersion, an average value, or a moving average value of the index to the evaluation period, and
the reference value is a maximum value, a minimum value, a median, a dispersion, an average value, or a moving average value of the index to the reference period.

8. The workload estimation system of claim 6, wherein
the work is sectioned on a unit period basis into a plurality of unit periods, and
the evaluation period includes the latest unit period out of the plurality of unit periods.

9. The workload estimation system of claim 6, wherein
the work is sectioned on a unit period basis into a plurality of unit periods, and
the evaluation period excludes the latest unit period out of the plurality of unit periods.

10. The workload estimation system of claim 8, wherein
the plurality of unit periods are set with respect to weekdays for the person, not with respect to days off for the person.

11. The workload estimation system of claim 6, wherein
the workload estimation unit is configured to:
when the evaluation value falls within a reference range including the reference value, estimate that the workload has not changed; and
when the evaluation value falls outside of the reference range, estimate that the workload has changed.

12. The workload estimation system of claim 6, wherein
the workload estimation unit is configured to estimate the workload status based on at least one of a frequency of occurrence of a state where the evaluation value falls within the reference range including the reference value or a frequency of occurrence of a state where the evaluation value falls outside of the reference range.

13. (canceled)

14. The workload estimation system of claim 1, wherein
the workload estimation unit is configured to, when finding a duration, for which the index continues to increase or decrease since the inflection point has been generated, equal to or greater than a time threshold value, estimate that the workload has changed.

15. The workload estimation system of claim 1, further comprising an estimation result storage unit configured to store the estimation result with respect to each of a plurality of the persons, wherein
the data output unit is configured to determine, in advance with respect to every destination to which the estimation data is to be output, at least one estimation result belonging to a plurality of the estimation results which is allowed to be included in the estimation data.

16. The workload estimation system of claim 15, wherein
the workload estimation unit and the data output unit are provided for a server device.

17. The workload estimation system of claim 1, wherein
the workload estimation unit is configured to estimate the workload status based on at least one of the business assignment data or the human resources data and answer data about the person's answer to a question.

18. The workload estimation system of claim 1, wherein
the workload estimation unit is configured to enter at least one of the business assignment data or the human resources data into a learned model established by machine learning and acquire the estimation result from the learned model.

19. The workload estimation system of claim 1, further comprising a data management unit configured to save at least one of the business assignment data or the human resources data.

20. A workload management system comprising:
the workload estimation system of claim 1; and
a display device configured to display the estimation data.

21. A workload estimation method, designed to be performed by a workload estimation system, for estimating a workload status indicating a degree of load placed by work on a person, the workload estimation method comprising:
a workload estimating step including estimating the workload status based on at least one of business assignment data about a history of business assignments that have been performed by the person or human resources data about human resources of the person; and
a data outputting step including outputting estimation data including an estimation result about the workload status,
the workload estimating step including
deriving, based on at least one of the business assignment data or the human resources data, an index represented by a numerical value; and
estimating the workload status by reference to an inflection point generated in time series data of the index.

22. (canceled)
